(19) United States
(12) Patent Application Publication
(10) Pub. No.: US 2020/0139455 A1
(43) Pub. Date: May 7, 2020

(54) HOLE CUTTER

(71) Applicant: TnC SHARK CO., LTD, Paju-si (KR)

(72) Inventor: Sung Kang JO, Seoul (KR)

(73) Assignee: TnC SHARK CO., LTD, Paju-si (KR)

(21) Appl. No.: 16/230,306

(22) Filed: Dec. 21, 2018

(30) Foreign Application Priority Data
Nov. 5, 2018 (KR) 10-2018-0134516

(51) Int. Cl. B23B 51/04

(52) U.S. Cl. CPC B23B 51/0406; B23B 2251/18

(57) ABSTRACT

Disclosed is a hole cutter capable of reducing a cutting load applied to a carbide tip during hole machining and improving cutting efficiency and workability. The hole cutter includes a cylindrical body, and a plurality of carbide tips disposed along an edge of the body. The carbide tips include a first carbide tip, a second carbide tip, and a third carbide tip. Assuming a circle which has a center coinciding with the body center and is in contact with a sharp tip of an upper surface portion of the first carbide tip, the second carbide tip is formed so that the sharp tip of an upper surface portion thereof is positioned at an inner region of the circle, and the third carbide tip is formed so that the sharp tip of an upper surface portion thereof is positioned at an outer region of the circle.

### CROSS-REFERENCE TO RELATED APPLICATIONS

This application claims the benefit of Korean Application No. 10-2018-0134516, filed Nov. 5, 2018, in the Korean Intellectual Property Office. All disclosures of the document named above are incorporated herein by reference.

### FIELD

The present invention relates to a hole cutter, and more particularly, to a hole cutter which is capable of reducing a cutting load applied to a carbide tip during hole machining and improving cutting efficiency and workability.

### BACKGROUND

Generally, a hole cutter is a tool which is helpfully used for forming a hole having a predetermined diameter or more in a plate material of various materials such as a thin steel plate or a wooden door, and is used in a state of being mounted on a drilling machine which provides a rotation force like a drill gun.

The hole cutter can be classified into a high-speed-steel hole cutter and a carbide-tipped hole cutter according to a shape of a cutting body. The high-speed-steel hole cutter refers to a hole cutter which has a serrated cutting edge and the carbide-tipped hole cutter refers to a hole cutter including a plurality of carbide tips provided on a body.

Such a hole cutter is mounted on a drilling machine such as a drill gun and can machine a hole having a predetermined diameter on a plate material such as wood or a steel plate by rotating the cutting edge.

In the various types of hole cutters described above, the carbide-tipped hole cutter will be described in more detail as follows. In the related art, the carbide-tipped hole cutter has a cylindrical hollow container, a plurality of carbide tips which are formed around one end portion of the hollow container, a drill holder which is formed with a shank coupled to a drill chuck, and a drill bit which is fixed by being fitted to the center of the other end portion of the drill holder.

Especially, the carbide tips of the carbide-tipped hole cutter of the related art have a tip shape with a sharp edge formed on the upper surface portion thereof and are disposed at equal intervals along an edge of one end portion of the hollow container. However, in the carbide-tipped hole cutter of the related art, a plurality of carbide tips are all formed to have the same shape and structure, and thus, there are the following problems (refer to Patent Documents 1, 2, and 3).

(1) in the related art, in a case of the carbide-tipped hole cutter, normally, only about 30% of the blade number of the carbide tip substantially participates in cutting during hole machining of a workpiece (for example, plate material) and this causes the cutting efficiency of the carbide-tipped hole cutter to be reduced and made the hole machining difficult.

(2) In a case where the cutting load is continuously applied to the carbide tip, there are problems that the carbide tip is stuck in the plate material, and the cutting edge is missed or broken to break the hole cutter or the rotation of the hole cutter is stopped.

(3) When the hole is machined to the plate material, the center hole drilled by the drill bit is widened, and the carbide tip is shaken so that the contact state of the cutting edge with respect to the plate material becomes unstable. In this case, there are problems that the hole is not precisely machined, the hole is drilled larger than the standard size, and the machined surface of the workpiece is not clean.

### SUMMARY

The present invention has been made to solve the problems described above, and an objective of the present invention is to provide a hole cutter, which is capable of performing cutting substantially by all the carbide tips of a hole cutter, reducing a cutting load applied to a cutting edge, and minimizing shaking of the cutting body generated during hole machined process.

So as to achieve the objectives, according to the present invention, there is provided a hole cutter including: a cylindrical body; and a plurality of carbide tips disposed along an edge of the body.

The carbide tips include a first carbide tip, a second carbide tip, and a third carbide tip.

When assuming a circle (hereinafter referred to as “reference circle”) which has a center coinciding with the body center and is in contact with a sharp tip of an upper surface portion of the first carbide tip, the second carbide tip is formed so that the sharp tip of an upper surface portion thereof is positioned at an inner region of the reference circle, and the third carbide tip is formed so that the sharp tip of an upper surface portion thereof is positioned at an outer region of the reference circle.

The upper surface portion of the first carbide tip may include a 1a machined surface; and a 1b machined surface. The 1b machined surface has a structure which is formed with a surface which is distinguished from the 1a machined surface with respect to a first boundary line and is connected to the 1a machined surface along the first boundary line. In this case, the first boundary line corresponds to the tip of the first carbide tip.

The upper surface portion of the second carbide tip may include a 2a machined surface; and a 2b machined surface. The 2b machined surface has a structure which is formed with a surface which is distinguished from the 2a machined surface with respect to a second boundary line and is connected to the 2a machined surface along the second boundary line. In this case, the second boundary line corresponds to the tip of the second carbide tip.

The separation distance between the second boundary line and the body center is formed to be less than the separation distance between the first boundary line and the body center.

The upper surface portion of the third carbide tip may include a 3a machined surface; and a 3b machined surface. The 3b machined surface has a structure which is formed with a surface which is distinguished from the 3a machined surface with respect to a third boundary line and is connected to the 3a machined surface along the third boundary line. In this case, the third boundary line corresponds to the tip of the third carbide tip.

The separation distance between the third boundary line and the body center is formed to be more than the separation distance between the first boundary line and the body center.

According to the hole cutter of the present invention, the carbide tips are configured with the first carbide tip, the second carbide tip, and the third carbide tip, which are different structures from each other, and thus this eventually allows all the carbide tips of the hole cutter to participate in the 100% cut. Thus, there are effects that the cutting efficiency of the carbide-tipped hole cutter can be maximized, the hole machining operation can be easily performed, and the working time can be shortened and the productivity can be improved compared to the carbide-tipped hole cutter of the related art.

According to the hole cutter of the present invention, it is possible to reduce the cutting load applied to the carbide tip and to implement a state of stably contacting the carbide tip plate material, thereby minimizing the shaking of the carbide tip. Accordingly, it is possible to prevent the problems that the carbide tip is stuck in the plate material and the carbide tip is missed or broken to break the hole cutter or the rotation of the hole cutter is stopped, and thus there are effects that it is possible to precisely machine holes that exactly fit the standard dimensions, and it is possible to secure a smooth and clean workpiece surface to be machined.

### BRIEF DESCRIPTION OF THE DRAWINGS

FIG. 1 is a perspective view illustrating a hole cutter according to the present invention.

FIG. 2 is a perspective view illustrating a first carbide tip according to the present invention.

FIG. 3 is a perspective view illustrating a second carbide tip according to the present invention.

FIG. 4 is a perspective view illustrating a third carbide tip according to the present invention.

FIG. 5 is a top view illustrating a cutting body according to the present invention.

FIG. 6(a) is a sectional view illustrating a second carbide tip according to the present invention.

FIG. 6(b) is a sectional view illustrating the first carbide tip according to the present invention.

FIG. 6(c) is a sectional view illustrating a third carbide tip according to the present invention.

### DESCRIPTION OF REFERENCE NUMERALS

10: cutting body 20: body of cutting body
21: cutting chip discharge groove 30: carbide tip
31: first carbide tip 31a: 1a machined surface
31b: 1b machined surface 32: second carbide tip
32a: 2a machined surface 32b: 2b machined surface
33: third carbide tip 33a: 3a machined surface
33b: 3b machined surface 40: drill bit
50: drill holder 51: holder body
52: shank 60: extraction spring
K1: first boundary line K2: second boundary line
K3: third boundary line C1: body center
S1: reference circle

### DETAILED DESCRIPTION

The terminology used herein is for the purpose of describing particular embodiments only and is not intended to be limiting of the invention. The singular representation includes plural representation unless the context clearly dictates otherwise. It should be understood that the terms “comprises”, “have”, and the like are intended to specify that there are features, numbers, steps, operations, components, parts or combination thereof which are described in the specification, but do not exclude the presence or addition of one or more other features, numbers, steps, operations, components, parts or combinations thereof, in advance.

In addition, in this specification, “on” or “above” means to be located above or below the object portion, which does not necessarily mean that the object is located on the upper side in the gravity direction. In other words, “on” or “above” as used herein, includes not only a case of locating above or below the object portion but also a case of locating before or after the object portion.

In addition, when a portion such as a region, a plate, or the like is located “on or above” the other portion, this includes not only a case of being directly in contact with the other portion or there is spacing therebetween, but also a case where there is another portion therebetween.

In addition, in this specification, it should be understood that when a component is referred to as “being coupled” or “being connected” to another component, the component may be directly coupled or directly connected to the other component, but unless an opposite description thereto is present, the component may be coupled or connected via another component therebetween.

In addition, in this specification, the terms first, second, or the like may be used to describe various components, but the components should not be limited by the terms. The terms are used only for the purpose of distinguishing one component from another.

Hereinafter, preferred embodiments, advantages, and features of the present invention will be described in detail with reference to the accompanying drawings.

For reference, the present invention can reduce the cutting load applied to the carbide tip during the hole machining and increase the cutting amount per unit revolution, that is, the cutting efficiency, and can minimize the shaking of the cutting body generated in the hole machining process, through the characteristic structure of, particularly, the carbide tip among the configurations of the hole cutter. Therefore, the structural characteristics of, particularly, the carbide tip, among the various configurations of the hole cutter, will be mainly described below.

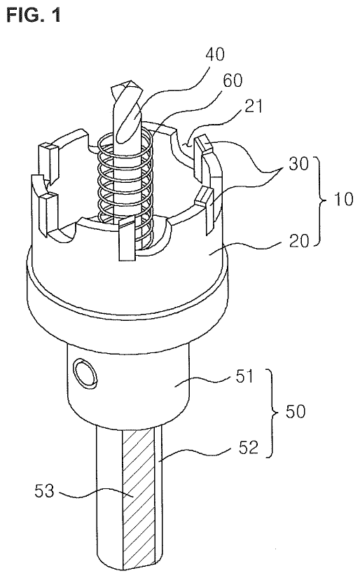

FIG. 1 is a perspective view illustrating a hole cutter according to the present invention. Referring to FIG. 1, a hole cutter according to the present invention may include a drill bit 40, a cutting body 10, and a drill holder 50, and may further include an extraction spring 60, preferably.

The drill bit 40 of the present invention is coupled to the drill holder 50 and is disposed on the center axis C1 of the cutting body 10 and a portion thereof is accommodated inside the cutting body 10, and another portion thereof protrudes outside the cutting body 10. Preferably, the drill bit 40 may be a twisted blade.

The drill bit 40 serves to prevent the momentary slippage of the cutting body 10 on the surface of the plate material when the plate material is cut by being pierced and inserted into the plate material just before cutting of the plate material by the cutting body 10 is started.

In addition, the drill bit 40 is located at the center point of the hole formed by the hole cutter, and pierces the center point, so that the carbide tip 30 comes into contact with the correct position with respect to the center point to pierce the hole with a predetermined diameter.

The cutting body of the present invention includes a body 20 and the carbide tip 30.

The body 20 of the cutting body 10 is configured such that one end surface thereof is opened and a length thereof is shorter than that of the drill bit 40 and thus the drill bit 40 can firstly protrude to an opening port.

The body 20 may be configured to have a cylindrical shape having an inner hollow space in which a portion of the drill bit 40 is accommodated. According to a preferred embodiment, the body 20 can be configured in a shape of a cylindrical container having an open top surface and a hollow interior.

The body 20 is fixed to the drill holder 50 together with the drill bit 40 so that the cutting body 10 can rotate together with the drill bit 40 when the drill bit 40 is rotated.

Meanwhile, the body 20 may have a plurality of carbide tip seating grooves and cutting chip discharge grooves 21 formed along the periphery thereof in the upper region (that is, opening port side).

The carbide tip seating groove (not illustrated) may be formed in a recessed structure on the body 20 as a configuration for coupling the carbide tip 30 to the body 20. In this case, the carbide tip 30 can be fixed to the body by being joined after the lower region thereof is seated in the seating groove. At this time, the carbide tip 30 can be joined and fixed to the body by a method such as welding or high-frequency fusion.

The cutting chip discharge groove 21 may be formed in a recessed structure on the upper portion of the body 20, as a configuration for discharging the cutting chips generated when the plate material is processed by the carbide tip 30 to the outside of the body 20.

A plurality of carbide tips 30 of the cutting body 10 are provided and are formed as a structure in which the plurality of carbide tips are disposed in the upper region of the body 20 along the edges thereof. The carbide tip 30 is configured to machine the hole by cutting the plate material by rotation of the cutting body. A detailed description of the structural features of the carbide tip 30 will be described below.

The drill holder 50 of the present invention includes a holder body 51 and a shank 52.

The holder body 51 is engaged with the drill bit 40 so that the drill bit 40 can be fixed on the central axis of the cutting body 10 and a shank 52 is formed at one end portion thereof.

The holder body 51 is formed to extend on a central lower surface of the body 20 of the cutting body and is configured such that the drill bit 40 can be mounted through an insertion hole which is formed by being passed through the center portion of the body 20 of the cutting body.

The shank 52 is formed to extend on the lower end portion of the holder body 51 and is coupled to the drill chuck to function to rotate the hole cutter in conjunction with driving of the drilling machine at the time of driving of the drilling machine.

Meanwhile, at least one planar fixing surface 53 may be formed on the side surface of the shank 52. The fixing surface 53 serves to prevent the shank 52, which is coupled to the drill chuck, from being idle.

The extraction spring 60 of the present invention is installed to surround the outer circumferential surface of the drill bit 40 and serves to remove the cutting chips generated during the hole cutting process from the inside of the cutting body 10.

Specifically, the extraction spring 60 is in a state of being elastically compressed while pushed by the plate material when cutting the plate material. When the hole cutting is completed, the extraction spring 60 returns to the original state thereof by the elastic restoring force. At this time, the cutting chip having lost the bonding force from the plate material is pushed out of the cutting body 10.

Hereinafter, the carbide tip of the present invention will be described in detail.

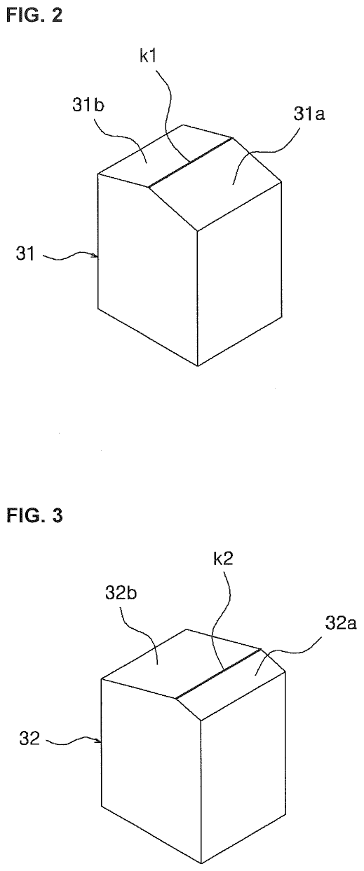

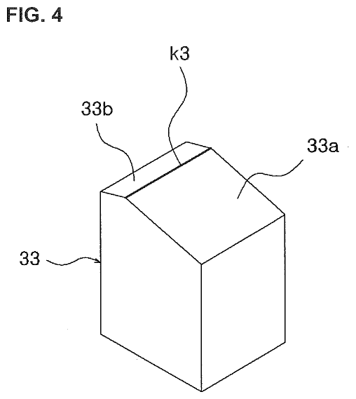

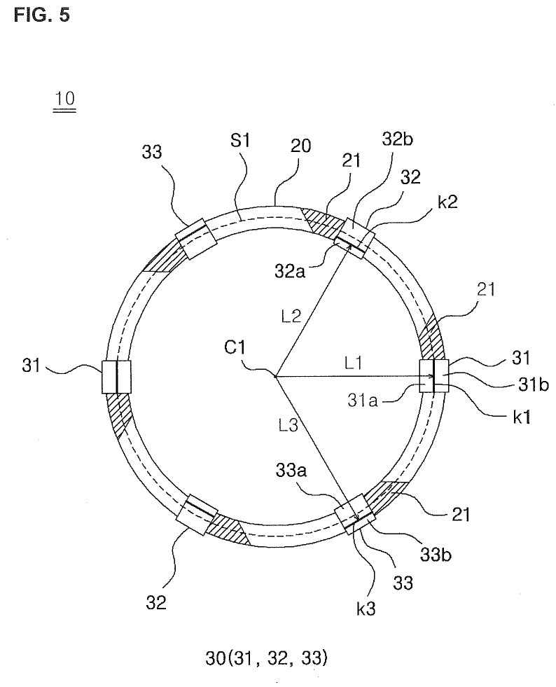

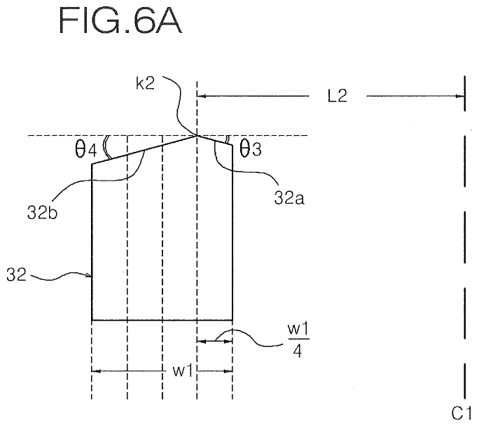

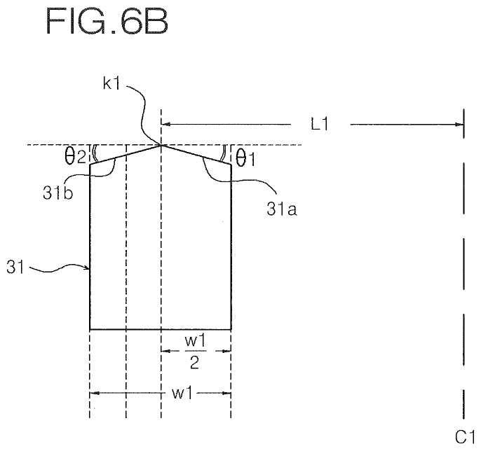

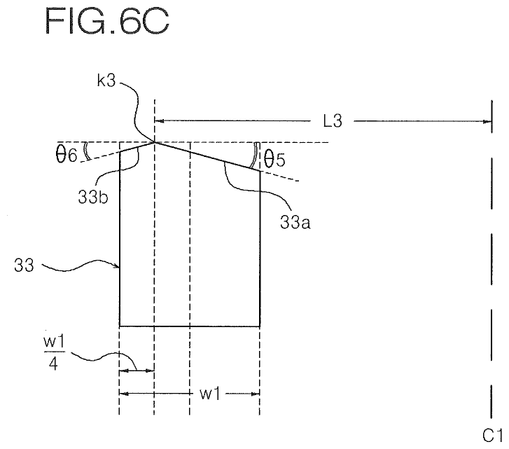

FIG. 2 is a perspective view illustrating a first carbide tip according to the present invention, FIG. 3 is a perspective view illustrating a second carbide tip according to the present invention, FIG. 4 is a perspective view illustrating a third carbide tip according to the present invention, FIG. 5 is a top view illustrating a cutting body according to the present invention, FIG. 6(a) is a sectional view illustrating a second carbide tip according to the present invention, FIG. 6(b) is a sectional view illustrating the first carbide tip according to the present invention, and FIG. 6(c) is a sectional view illustrating a third carbide tip according to the present invention.

Referring to FIGS. 2 to 6, the carbide tip 30 of the present invention is formed in the shape of a blade whose upper tip is in contact with the plate material to cause cutting.

The carbide tip 30 is seated and joined to a plurality of carbide tip seating grooves formed in the body 20 in an oblique structure.

Specifically, the carbide tip 30 may have a structure inclined by 10 to 15° with respect to the vertical direction of the body. When the inclination of the carbide tip 30 is less than 10°, a phenomenon that the machined surface of the workpiece is rough and torn is generated. When the inclination of the carbide tip 30 is more than 15°, a trembling phenomenon occurs when machining a workpiece, and thus it is difficult to smoothly carry out the work.

The carbide tip 30 can be firmly fixed to the body 20 by a reliable joining method such as welding, high frequency fusion or the like so as not to be missed from the body 20 even if the plate material is repeatedly cut.

The carbide tip 30 may be formed of a high-strength metal material, for example, a diamond steel material for industrial use.

According to the present invention, a plurality of carbide tips 30 are provided, and the plurality of carbide tips include a first carbide tip 31, a second carbide tip 32, and a third carbide tip 33.

For reference, the term “upper surface portion of carbide tip” used herein refers to a portion which is in contact with a workpiece or faces the workpiece when machining the workpiece and includes a machined surface and a tip in detail. The term “tip of carbide tip” is a portion which is formed in the shape of a sharp line at the end of the front side (that is, upper surface portion side) of the carbide tip, and specifically means a blade portion which contacts the workpiece among the upper surface portions of the carbide tip, and thus actually cuts the workpiece. For reference, a first boundary line K1, a second boundary line K2, and a third boundary line K3, which will be described below, correspond to the tip of each carbide tip.

The first carbide tip 31, the second carbide tip 32, and the third carbide tip 33 of the present invention are distinguished from each other with respect to the upper surface portion structure and the tip position of the corresponding carbide tip.

Specifically, it is assumed that a circle (hereinafter, referred to as “reference circle S1”) which is in contact with the tip of the first carbide tip 31. The reference circle S1 corresponds to a circle whose center C1 is coincident with the body center C1.

Based on the above assumption, the tip of the second carbide tip 32 is formed to be located in the inner region of the reference circle S1. The tip of the third carbide tip 33 is formed to be located in the outer region of the reference circle S1.

Meanwhile, the first carbide tip 31, the second carbide tip 32, and the third carbide tip 33 of the present invention all may be formed to have the same width (see “W1” in FIG. 6).

The upper surface portion of the first carbide tip 31 includes a 1a machined surface 31a, a 1b machined surface 31b, and a first boundary line K1.

The 1a machined surface 31a is one surface constituting the upper surface portion of the first carbide tip 31, and the 1a machined surface 31a corresponds a surface which is distinguished from the 1b machined surface 31b with respect to the first boundary line K1.

The 1a machined surface 31a may be formed in a surface shape including a flat surface or a curved surface, and may preferably be configured as a flat surface.

The 1a machined surface 31a has a structure in which the 1a machined surface 31a is in contact with another surface starting from the first boundary line K1. The other surface in contact with the 1a machined surface 31a corresponds to the 1b machined surface 31b.

The 1b machined surface 31b is another surface constituting the upper surface portion of the first carbide tip 31 and corresponds to a surface which is distinguished from the 1a machined surface 31a with respect to the first boundary line K1.

The 1a machined surface 31a may be formed as a surface shape including a flat surface or a curved surface, and may preferably be configured in a flat surface.

The 1b machined surface 31b has a structure in which the 1b machined surface 31b is connected to the 1a machined surface 31a along the first boundary line K1 so that the two surfaces (that is, 1a and 1b machining surfaces) which are distinguished from each other with respect to the first boundary line K1 form a structure forming the upper surface portion of the first carbide tip 31.

The 1b machined surface 31b is configured to be a surface located further outward than the 1a machined surface 31a with respect to the first boundary line K1. In other words, the 1b machined surface 31b is configured to be a surface located farther from the 1a machined surface 31a from the body center C1 to the inside of the body 20 with respect to the first boundary line K1.

The first boundary line K1 of the first carbide tip 31 is a line portion which is formed by the 1a machined surface 31a and the 1b machined surface 31b being in contact with each other, and the line portion also corresponds to the tip of the first carbide tip 31.

According to the preferred embodiment, the first carbide tip 31 may be configured such that the first boundary line K1 is located on the center of the width W1 of the first carbide tip 31. In other words, the first carbide tip 31 may be formed at a position spaced apart from the inner end of the first carbide tip 31 by a half of the width W1 of the first carbide tip 31 as illustrated in FIG. 6(b) (that is, “W½” of FIG. 6(b)). In this case, the 1a machined surface 31a and the 1b machined surface 31b may be formed to have the same shape and the same area as each other.

The 1a machined surface 31a is formed so as to be inclined downward from the first boundary line K1 in the inner direction of the first carbide tip 31. Preferably, the 1a machined surface 31a may be formed to be inclined downward by an angle 81 of 12° to 18°.

The 1b machined surface 31b is formed to be inclined downward from the first boundary line K1 in the outer direction of the first carbide tip 31. Preferably, the 1b machined surface 31b may be formed to be inclined downward by an angle 82 of 12° to 18°.

When the inclination angles θ1 and θ2 of the 1a and 1b machined surfaces are formed to be less than 12°, the initial contact area with the workpiece is widened and a considerable cutting load is applied. According to this, there is a problem that the cutting edge is stuck in the plate material, and the cutting edge is missed or broken and the hole cutter is broken, or the hole cutter stops rotating.

When the inclination angles θ1 and θ2 of the 1a and 1b machined surfaces are more than 18°, the tip portion (that is, first boundary line portion) of the first carbide tip 31 is quickly worn out and thus the hole cutter life is shortened.

Therefore, it is preferable that the 1a and 1b machined surfaces are formed as inclined surfaces of angles θ1 and 82 of 12° to 18°.

The upper surface portion of the second carbide tip 32 includes a 2a machined surface 32a, a 2b machined surface 32b, and a second boundary line K2.

The 2a machined surface 32a is one surface constituting the upper surface portion of the second carbide tip 32 and the 2a machined surface 32a corresponds to a surface which is distinguished from the 2b machined surface 32b with respect to the second boundary line K2.

The 2a machined surface 32a may be formed in a form of a surface including a flat surface or a curved surface, and may preferably be constituted by a flat surface.

The 2a machined surface 32a has a structure in which the 2a machined surface 32a is in contact with another surface starting from the second boundary line K2. In this way, the other surface which is in contact with the 2a machined surface 32a corresponds to the 2b machined surface 32b.

The 2b machined surface 32b is another surface constituting the upper surface portion of the second carbide tip 32 and corresponds to a surface which is distinguished from the 2a machined surface 32a with respect to the second boundary line K2.

The 2b machined surface 32b may be formed in a form of a surface including a flat surface or a curved surface, and may preferably be constituted by a flat surface.

The 2b machined surface 32b has a structure in which the 2b machined surface 32b is connected to the 2a machined surface 32a along the second boundary line K2 so that the two surfaces (that is, 2a and 2b machined surfaces) which are distinguished from each other with respect to the second boundary line K2 has a structure forming the upper surface portion of the second carbide tip 32.

The 2b machined surface 32b is configured to be a surface located further outward than the 2a machined surface 32a with respect to the second boundary line K2. In other words, the 2b machined surface 32b is configured to be a surface located farther from the 2a machined surface 32a from the body center C1 to the inside of the body 20 with respect to the second boundary line K2.

The 2a machined surface 32a is configured with another surface which is distinguished from the side surfaces of the second carbide tip 32, but, as an alternative embodiment, the 2a machined surface 32a may be configured as one side surface of the second carbide tip 32. In this case, the 2b machined surface 32b has a structure in which the 2b machined surface 32b is connected to one side surface of the second carbide tip 32 starting from the second boundary line K2, and, at this time, the one side surface of the second carbide tip 32 corresponds to the 2a machined surface 32a.

The second boundary line K2 of the second carbide tip 32 is a line portion formed by contacting the 2a machined surface 32a and the 2b machined surface 32b each other and the line portion also corresponds to the tip of second carbide tip 32.

The second carbide tip 32 is configured such that the separation distance L2 between the second boundary line K2 and the body center C1 is less than the separation distance L1 between the first boundary line K1 and the body center C1. In other words, the second carbide tip 32 is configured such that the tip thereof is located in the inner region of the reference circle S1 described above.

According to a preferred embodiment, the second boundary line K2 may be formed at a position which is spaced apart from the inner end of the second carbide tip 32 by ¼ of the width W1 of the second carbide tip 32 as in FIG. 6(a) (that is, “W¼” in FIG. 6(a)). In this case, the 2a machined surface 32a may be formed as a surface having a smaller area than the 2b machined surface 32b.

The 2a machined surface 32a is formed to be inclined downward from the second boundary line K2 in the inside direction of the second carbide tip 32. Preferably, the 2a machined surface 32a may be formed to be inclined downward by an angle θ3 of 12° to 18°.

The 2b machined surface 32b is formed to be inclined downward from the second boundary line K2 in the outside direction of the second carbide tip 32. Preferably, the 2a machined surface 32a may be formed to be inclined downward by an angle θ4 of 12° to 18°.

When the inclination angles θ3 and θ4 of the 2a and 2b machined surfaces are formed to be less than 12°, an initial contact area with the workpiece is widened and a considerable cutting load is applied. This may cause a problem that the cutting edge is stuck in the plate material, the cutting edge is missed or broken and the hole cutter is broken or the rotation of the hole cutter is stopped.

When the inclination angles θ3 and θ4 of the 2a and 2b machined surfaces are formed to be more than 18°, the tip portion (that is, second boundary line portion) of the second carbide tip 32 is quickly worn out and thus the hole cutter life is shortened.

Therefore, it is preferable that the 2a and 2b machined surfaces are formed as inclined surfaces of angles θ3 and θ4 of 12° to 18°.

The upper surface portion of the third carbide tip 33 includes a 3a machined surface 33a, a 3b machined surface 33b, and a third boundary line K3.

The 3a machined surface 33a is a surface constituting the upper surface portion of the third carbide tip 33 and the 3a machined surface 33a corresponds to a surface which is distinguished from the 3b machined surface 33b with respect to the third boundary line K3.

The 3a machined surface 33a may be formed in a surface shape including a flat surface or a curved surface, and preferably, may be a flat surface.

The 3a machined surface 33a has a structure in which the 3a machined surface 33a is in contact with another surface starting from the third boundary line K3. In this way, the other surface contacting the 3a machined surface 33a corresponds to the 3b machined surface 33b.

The 3b machined surface 33b is another surface constituting the upper surface portion of the third carbide tip 33 and corresponds to a surface which is distinguished from the 3a machined surface 33a with respect to the third boundary line K3.

The 3b machined surface 33b may be formed in a surface shape including a flat surface or a curved surface, and preferably, may be a flat surface.

The 3b machined surface 33b has a structure in which the 3b machined surface 33b is connected to the 3a machined surface 33a along the third boundary line K3 so that the two surfaces (that is, 3a, 3b machined surface) which are distinguished from each other with respect to the third boundary line K3 has a structure which forms the upper surface portion of the third carbide tip 33.

The 3b machined surface 33b is configured to be a surface located further outside than the 3a machined surface 33a with respect to the third boundary line K3. In other words, the 3b machined surface 33b is configured to be a surface located farther from the 3a machined surface 33a from the body center C1 to the inside of the body 20 with respect to the third boundary line K3.

The 3b machined surface 33b is configured with another surface which is distinguished from the side surfaces of the third carbide tip 33, but, as an alternative embodiment, the 3b machined surface 33b may be configured as one side surface of the third carbide tip 33. In this case, the 3a machined surface 33a has a structure in which the 3a machined surface 33a is connected to one side surface of the third carbide tip 33 starting from the third boundary line K3, and, at this time, the one side surface of the third carbide tip 33 corresponds to the 3a machined surface 33a.

The third boundary line K3 of the third carbide tip 33 is a line portion formed by contacting the 3a machined surface 33a and the 3b machined surface 33b each other and the line portion also corresponds to the tip of third carbide tip 33.

The third carbide tip 33 is configured such that the separation distance L3 between the third boundary line K3 and the body center C1 is more than the separation distance L1 between the first boundary line K1 and the body center C1. In other words, the third carbide tip 33 is configured such that the tip thereof is located in the outer region of the reference circle S1 described above.

According to a preferred embodiment, the third boundary line K3 may be formed at a position which is spaced apart from the outer end of the third carbide tip 33 by ¼ of the width W1 of the third carbide tip 33 as in FIG. 6(c) (that is, “W¼” in FIG. 6(c)). In this case, the 3a machined surface 33a may be formed as a surface having a larger area than the 3b machined surface 33b.

The 3a machined surface 33a is formed to be inclined downward from the third boundary line K3 in the inside direction of the third carbide tip 33. Preferably, the 3a machined surface 33a may be formed to be inclined downward by an angle θ5 of 12° to 18°.

The 3b machined surface 33b is formed to be inclined downward from the third boundary line K3 in the outside direction of the third carbide tip 33. Preferably, the 3a machined surface 33a may be formed to be inclined downward by an angle θ6 of 12° to 18°.

When the inclination angles θ5 and θ6 of the 3a and 3b machined surfaces are formed to be less than 12°, an initial contact area with the workpiece is widened and a considerable cutting load is applied. This may cause a problem that the cutting edge is stuck in the plate material, the cutting edge is missed or broken and the hole cutter is broken or the rotation of the hole cutter is stopped.

When the inclination angles θ5 and θ6 of the 3a and 3b machined surfaces are formed to be more than 18°, the tip portion (that is, third boundary line portion) of the third carbide tip 33 is quickly worn out and thus the hole cutter life is shortened.

Therefore, it is preferable that the 3a and 3b machined surfaces are formed as inclined surfaces of angles θ5 and θ6 of 12° to 18°.

The hole cutter of the present invention exhibits the following operational effects by the structural features of the carbide tip described above.

For reference, in the related art, in a case of carbide-tipped hole cutter, normally, only about 30% of the blade number of the carbide tip is actually involved in cutting during hole machining of a workpiece (for example, plate material) and this causes the cutting efficiency of the carbide-tipped hole cutter to be reduced and made the hole machining difficult.

According to the carbide-tipped hole cutter of the present invention, the carbide tips include the first carbide tip 31, the second carbide tip 32, and the third carbide tip 33 having different structures from each other, and this eventually allows all the carbide tips of the hole cutter to participate in the 100% cut. Accordingly, the cutting efficiency of the carbide-tipped hole cutter can be maximized, the hole machining operation can be easily performed, and the working time can be shortened and the productivity can be improved compared to the carbide-tipped hole cutter of the related art.

In addition, it is possible to reduce the cutting load applied to the carbide tip and to implement a state of stably contacting the carbide tip plate material, thereby minimizing the shaking of the carbide tip. Accordingly, it is possible to prevent the problem that the carbide tip is stuck in the plate material and the carbide tip is missed or broken to break the hole cutter or the rotation of the hole cutter is stopped, and thus it is possible to precisely machine holes that exactly fit the standard dimensions, and it is possible to secure a smooth and clean workpiece surface to be machined.

While the preferred embodiments of the present invention have been described and illustrated above using specific terms, such terms are used only for the purpose of clarifying the invention, and in the embodiments of the described terms of the present invention, it will be obvious that various changes and modifications may be made without departing from the spirit and scope of the following claims. Such modified embodiments should not be understood individually from the spirit and scope of the present invention but should be regarded as being within the scope of the claims of the present invention.

What is claimed is:

1. A hole cutter which includes a cylindrical body, and a plurality of carbide tips disposed along an edge of the body,
wherein the carbide tips include a first carbide tip, a second carbide tip, and a third carbide tip,
wherein, when assuming a circle (hereinafter, referred to as “reference circle S1”) having a center coinciding with the body center C1 and contacting a tip of the first carbide tip, the second carbide tip is formed so that a tip thereof is positioned at an inner region of the reference circle S1, and the third carbide tip is formed so that a tip thereof is positioned at an outer region of the reference circle S1.

2. The hole cutter according to claim 1,
wherein the first carbide tip includes
a 1a machined surface, and
a 1b machined surface which has a structure which is formed with a surface which is distinguished from the 1a machined surface with respect to a first boundary line K1 and is connected to the 1a machined surface along the first boundary line K1, and
wherein the first boundary line K1 is the tip of the first carbide tip.

3. The hole cutter according to claim 2,
wherein the first boundary line K1 is positioned on a center of a width of the first carbide tip.

4. The hole cutter according to claim 2,
wherein the second carbide tip includes
a 2a machined surface, and
a 2b machined surface which has a structure which is formed with a surface which is distinguished from the 2a machined surface with respect to a second boundary line K2 and is connected to the 2a machined surface along the second boundary line K2,
wherein the second boundary line K2 is the tip of the second carbide tip, and
wherein a separation distance between the second boundary line K2 and the body center C1 is less than a separation distance between the first boundary line K1 and the body center C1.

5. The hole cutter according to claim 2,
wherein the third carbide tip includes
a 3a machined surface, and
a 3b machined surface which has a structure which is formed with a surface which is distinguished from the 3a machined surface with respect to a third boundary line K3 and is connected to the 3a machined surface along the third boundary line K3,
wherein the third boundary line K3 is the tip of the third carbide tip, and
wherein a separation distance between the third boundary line K3 and the body center C1 is more than a separation distance between the first boundary line K1 and the body center C1.

6. The hole cutter according to claim 4,
wherein the second boundary line K2 is formed at a position which is spaced apart from an inner end of the second carbide tip by ¼ of a width of the second carbide tip.

7. The hole cutter according to claim 5,
wherein the third boundary line K3 is formed at a position which is spaced apart from an outer end of the second carbide tip by ¼ of a width of the second carbide tip.

8. The hole cutter according to claim 2,
wherein the 1a machined surface and the 1b machined surface are formed with inclined surfaces of 12° to 18°, respectively.

9. The hole cutter according to claim 4,
wherein the 2a machined surface and the 2b machined surface are formed with inclined surfaces of 12° to 18°, respectively.

10. The hole cutter according to claim 5,
wherein the 3a machined surface and the 3b machined surface are formed with inclined surfaces of 12° to 18°, respectively.

11. The hole cutter according to claim 4,
wherein the third carbide tip includes
a 3a machined surface, and
a 3b machined surface which has a structure which is formed with a surface which is distinguished from the 3a machined surface with respect to a third boundary line K3 and is connected to the 3a machined surface along the third boundary line K3,
wherein the third boundary line K3 is the tip of the third carbide tip, and
wherein a separation distance between the third boundary line K3 and the body center C1 is more than a separation distance between the first boundary line K1 and the body center C1.

12. The hole cutter according to claim 11,
wherein the third boundary line K3 is formed on a position which is spaced apart from an outer end of the second carbide tip by ¼ of a width of the second carbide tip.

13. The hole cutter according to claim 11,
wherein the 3a machined surface and the 3b machined surface are formed with inclined surfaces of 12° to 18°, respectively.
